(19) United States
(12) Patent Application Publication
(10) Pub. No.: US 2011/0056452 A1
(43) Pub. Date: Mar. 10, 2011

(54) Gravity-Activated Valve For Use In Supplying An Uninterrupted Supply Of Fluid

(75) Inventors: Joshua Horner, Oak Park, IL (US); Tyler R. Vincer, Elmhurst, IL (US); Nicholas E. Burke, Chicago, IL (US)

(73) Assignee: International Truck Intellectual Property Company, LLC, Warrenville, IL (US)

(21) Appl. No.: 12/554,117

(22) Filed: Sep. 4, 2009

(51) Int. Cl. F16K 15/00; B67D 5/00

(52) U.S. Cl. 123/188.4; 137/532; 222/3

(57) ABSTRACT

A gravity-activated valve for use in supplying an uninterrupted supply of fluid is disclosed. The valve includes a housing having an outlet, an inlet positioned below the outlet, and a sleeve disposed within the housing. The valve also includes a buoyant piston disposed within the sleeve, which is adapted to move between an open position and a closed position. The piston is positioned above the outlet when the piston is in the open position to allow fluid flow through the outlet and positioned proximate the outlet in the closed position to prevent fluid flow through the outlet. The piston is in the open position when the fluid level exceeds a predetermined fluid level and in the closed position when the fluid level is at or below the predetermined fluid level. The valve further includes a plurality of gaskets, which are adapted to create a seal between the piston and the sleeve.

### FIELD OF THE INVENTION

The present invention concerns a lubricating system for an internal combustion engine for supplying an uninterrupted supply of fluid, and more particularly relates to a gravity-activated valve for use in supplying an uninterrupted supply of fluid from a fluid reservoir.

### BACKGROUND

Many engines require special handling of fluids to provide a constant supply of fluids to each respective system at high grades, including steep inclines or declines, braking and acceleration, or parking on an inclined or decline. Fluids move due to gravity at different tilt angles and may not always be accessible from one static supply point in a reservoir. When the fluid is inaccessible because of these conditions, the engine may stall due to an improper intake of air and/or vapor.

Additionally, not all existing engines have the capability to accept full redesigns of a fluid system. Instead, they may need to be retrofitted with other hardware designed to provide a constant flow under a high range of vehicle grades.

### SUMMARY

A gravity-activated valve for use in supplying an uninterrupted supply of fluid from a fluid reservoir is disclosed. The gravity-activated valve includes a housing having an outlet, an inlet positioned below the outlet, and a sleeve disposed within the housing. The gravity-activated valve further includes a buoyant piston disposed within the sleeve and adapted to move between an open position and a closed position. The piston is positioned above the outlet when the piston is in the open position to allow fluid flow through the outlet. The piston is positioned proximate the outlet when the piston is in the closed position to prevent fluid flow through the outlet. The piston is in the open position when the fluid level exceeds a predetermined fluid level. The piston is in the closed position when the fluid level is at or below said predetermined fluid level. The gravity-activated valve further includes a plurality of gaskets, which are adapted to create a seal between the piston and the sleeve.

Also disclosed is a valve that may be used in a lubricating system for an internal combustion engine for supplying an uninterrupted supply of fluid. The lubricating system comprises a reservoir for holding lubricating fluid. The reservoir includes a sump. The lubricating system further includes a plurality of valves located in the sump. Each of the valves comprises a housing having an outlet, an inlet positioned below the outlet, and a tubular cavity disposed within the housing. The valves further include a buoyant piston disposed within the tubular cavity and adapted to move between an open position and a closed position. The piston is positioned above the outlet when the piston is in the open position to allow fluid flow through the outlet. The piston is positioned proximate to the outlet when the piston is in the closed position to prevent fluid flow through the outlet. The piston is responsive to the level of the fluid in the reservoir at the inlet such that the piston is in the open position when the fluid level at the inlet is above a predetermined level and the piston is in the closed position when the fluid level at the inlet is at or below the predetermined level. The valves further comprise a plurality of gaskets, which are adapted to create a seal between the piston and the sleeve. The lubricating system further contains a pump which is in fluid communication with the outlet of each of the valves.

Further disclosed is a reservoir for supplying an uninterrupted supply of fluid. The reservoir includes a sump for holding fluid and a plurality of valves located in the sump. The valves include a housing having an outlet, an inlet positioned below the outlet, and a sleeve disposed within the housing. The valves further include a buoyant piston disposed within the sleeve. The piston is adapted to move between an open position and a closed position. The piston is positioned above the outlet when the piston is in the open position to allow fluid flow through the outlet. The piston is positioned proximate to the outlet when the piston is in the closed position to prevent fluid flow through the outlet. The piston is in the open position when the fluid level exceeds a predetermined fluid level and the piston is in the closed position when the fluid level is at or below the predetermined level. The valves further include a plurality of gaskets, which are adapted to create a seal between the piston and the sleeve. The valves further contain a mounting flange, which is connected to the housing and the sump.

These disclosed valve and related disclosures will be understood and appreciated by those skilled in the art upon studying the following specification, claims and appended drawings.

### BRIEF DESCRIPTION OF DRAWINGS

FIG. 1 is front cross-sectional view of one embodiment of a gravity-activated valve of the present invention in the open position.

FIG. 2 is front cross-sectional view of one embodiment of a gravity-activated valve of the present invention in the closed position.

FIG. 3 is front cross-sectional view of an alternative embodiment of a gravity-activated valve of the present invention in the open position.

FIG. 4 is front cross-sectional view of an alternative embodiment of a gravity-activated valve of the present invention in the closed position.

FIG. 5 is front cross-sectional view of an alternative embodiment of a lubricating system of the present invention.

FIG. 6 is front cross-sectional view of an alternative embodiment of a lubricating system of the present invention.

FIG. 7 is top perspective view of an alternative embodiment of a lubricating system of the present invention.

### DETAILED DESCRIPTION OF PREFERRED EMBODIMENTS

The best mode for carrying out the claimed invention is presented below, wherein similar reference characters designate corresponding features throughout the several figures of the drawings.

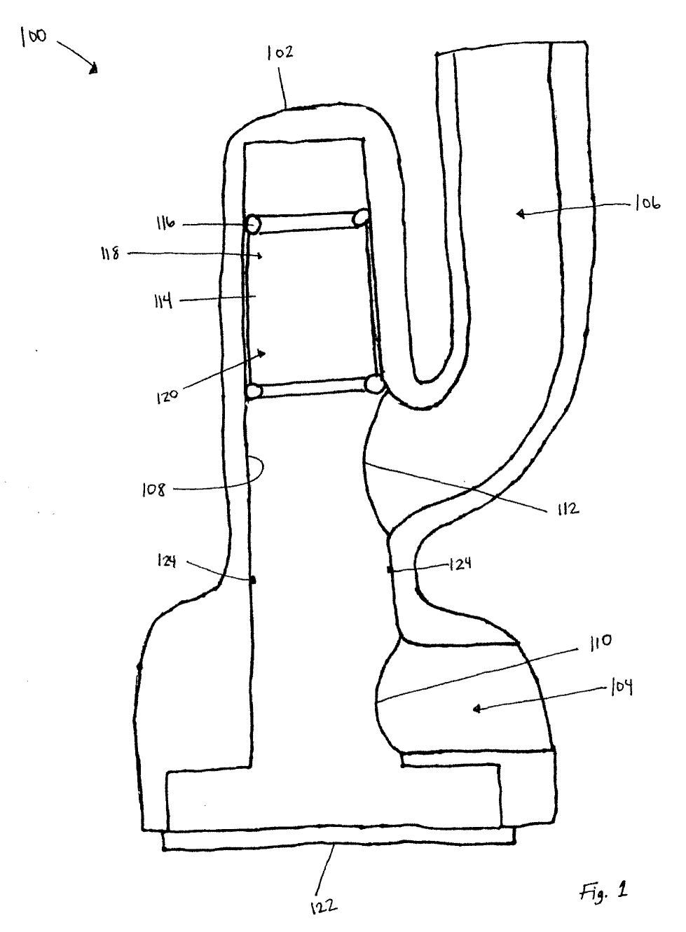

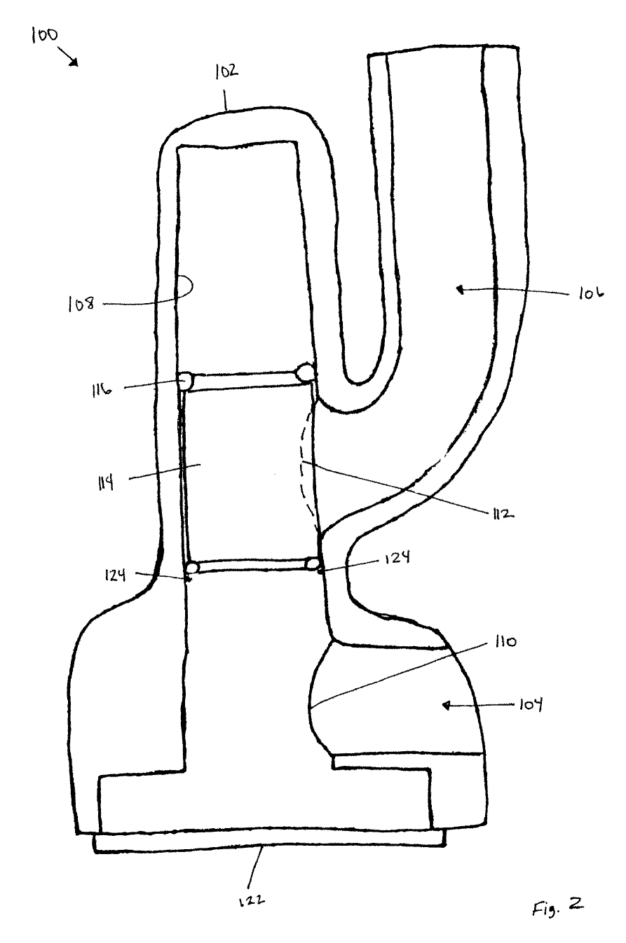

Referring now to the drawings, particularly FIGS. 1 and 2, there is shown an embodiment of a gravity-activated valve 100 of the present invention. The valve 100 contains a housing 102 which encases and protects the internal components of the valve 100. The housing contains an inlet 104 and an outlet 106. The inlet 104 is a conduit through which fluids may enter the valve 100. As shown in FIGS. 1 and 2, the outlet 106 is positioned above the inlet 104 on the valve 100. The outlet 106 is a conduit through which fluids may exit the valve 100.

The valve 100 also contains a tubular cavity or sleeve 108. In one embodiment, the tubular cavity or sleeve 108 is a hollowed cylindrical portion within the valve 100. In this embodiment, the tubular cavity or sleeve 108 and the housing 102 are one integral piece, where the tubular cavity or sleeve 108 may be formed during casting of the housing or by a subsequent machinery step through, for example, a drill press. In an alternative embodiment, the valve may contain a tubular cavity or sleeve 108 which is a separate component disposed within housing 102.

As also shown in FIGS. 1 and 2, the tubular cavity or sleeve 108 may also contain an intake opening 110 and an exit opening 112. In one embodiment, the intake opening 110 is in fluid communication with inlet 104 and the exit opening 112 is in fluid communication with the outlet 106. The sleeve or tubular cavity 108 may also be in any shape known to one of ordinary skill including, but not limited to, circular, oval, square, rectangular or octagonal.

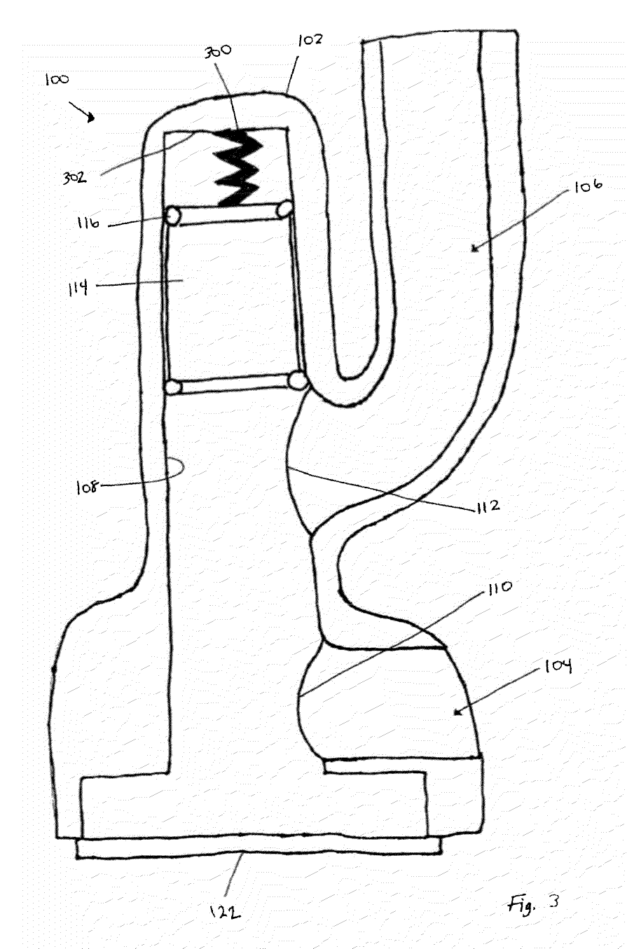

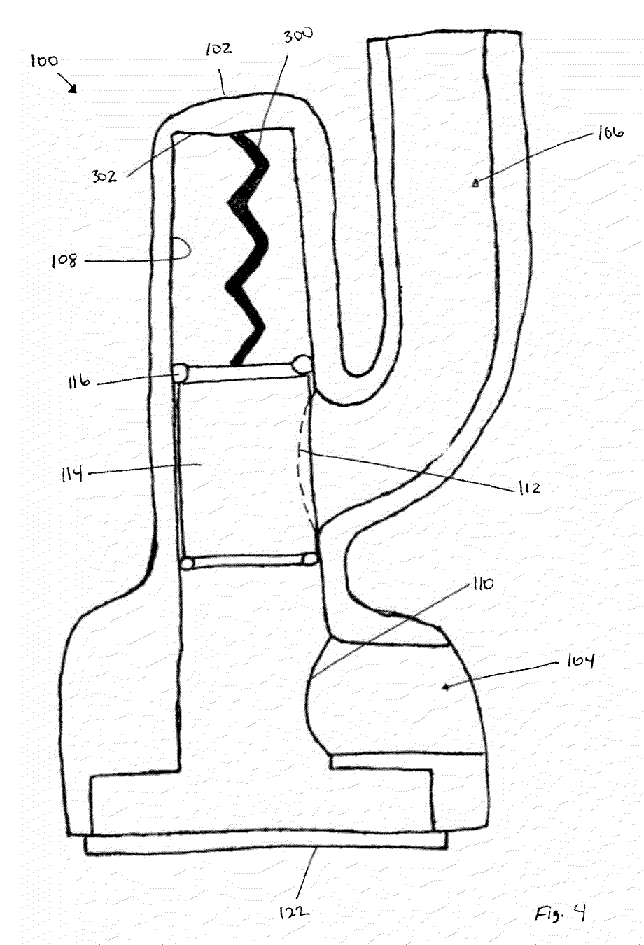

The valve also contains a buoyant piston 114 which is disposed within the tubular cavity or sleeve 108. The piston 114 may be made of any material which is sufficiently buoyant on the type of fluid which will flow through the valve 100. The piston 114 is adapted to move between an open position, as shown in FIGS. 1 and 3, and a closed position, as shown in FIGS. 2 and 4. The piston 114 is positioned above the outlet 106 when the piston is in the open position to allow fluid flow through the outlet 106. The piston is positioned proximate the outlet 106 when the piston is in the closed position to prevent fluid flow through the outlet 106. The piston is in the open position when the fluid level exceeds a predetermined fluid level in and the piston is in the closed position when the fluid level is at or below said predetermined fluid level. The predetermined level is the level of fluid which is present in the valve which makes the piston 114 move from the open position to the closed position. When the level of the fluid is at or below the predetermined level, the piston 114 will completely block the outlet 106 and prevent the flow of fluid through the outlet 106. When the fluid level is above the predetermined level, the piston 114, will not completely block the outlet 106 and allow fluid to flow out through the outlet 106. The open position is any position between the closed position, where fluid flow is prevented through the outlet 106, and the placement of the piston when it is completely open, and the fluid is at a maximum fluid flow through the outlet 106. The piston 114 may be in the open position so long as there is fluid communication through the outlet 106 of the valve 100.

The piston 114 may include a plurality of gaskets 116. The gaskets 116 are adapted to create a seal between the piston and the sleeve. The purpose of the gaskets is to prevent gases, such as air, below the piston 114 from entering the exit opening 112 when the piston 114 is in the closed position. The gaskets also prevent fluid from entering the space above the piston 114 when the piston is disposed within the sleeve or tubular cavity 108. In one embodiment, as shown in FIGS. 1-6, the gaskets are located on the top section 118 and the bottom section 120 of the piston 114. In one embodiment, the plurality of gaskets 116 may comprise a plurality of o-rings. The gaskets may also comprise any other type of gasket known in the art which would provide a similar seal and ability to slide the piston 114 along the sleeve or tubular cavity 108.

In one embodiment, as shown in FIGS. 1 and 2, the piston 114 may be freely moveable within the sleeve or tubular cavity 108. In this embodiment, the level of fluid in the sleeve or tubular cavity 108 alone determines the height of the piston 114 within the sleeve or tubular cavity 108. When there is no fluid present in this embodiment, then the piston 114 naturally gravitates towards the lower portion of the sleeve or tubular cavity 108 and rests on stops 124, which prevent fluid from the exiting the valve 100 through the outlet 106.

In an alternative embodiment, as shown in FIGS. 3 and 4, the top section 118 of the piston 114 may be connected to a spring 300, which is attached to the upper portion 302 of the sleeve or tubular cavity 108. In this embodiment, the spring 300 operatively cooperates with the piston to urge the piston to the closed position, as shown in FIG. 4. As shown in FIG. 3, when fluid is present in the sleeve or tubular cavity 108, the spring 300 is compressed and the piston 114 is moved into the open position.

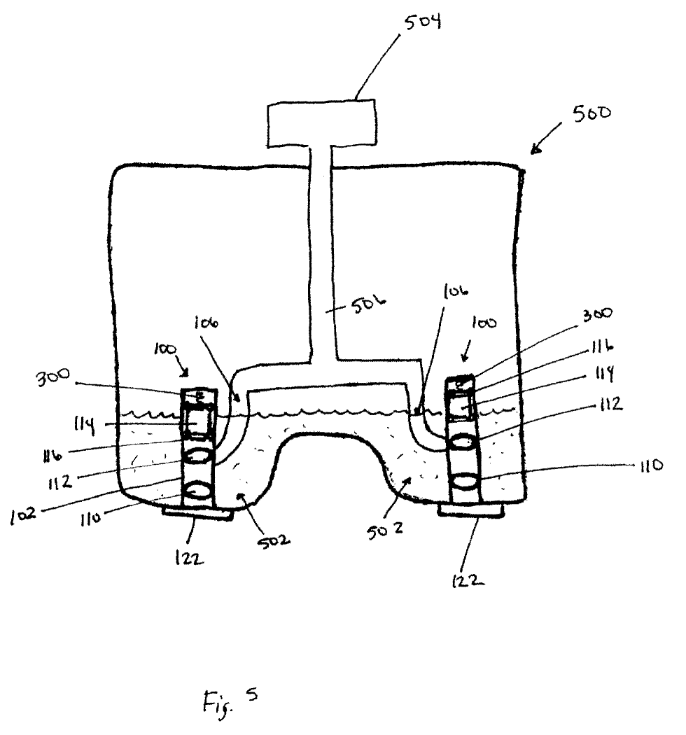

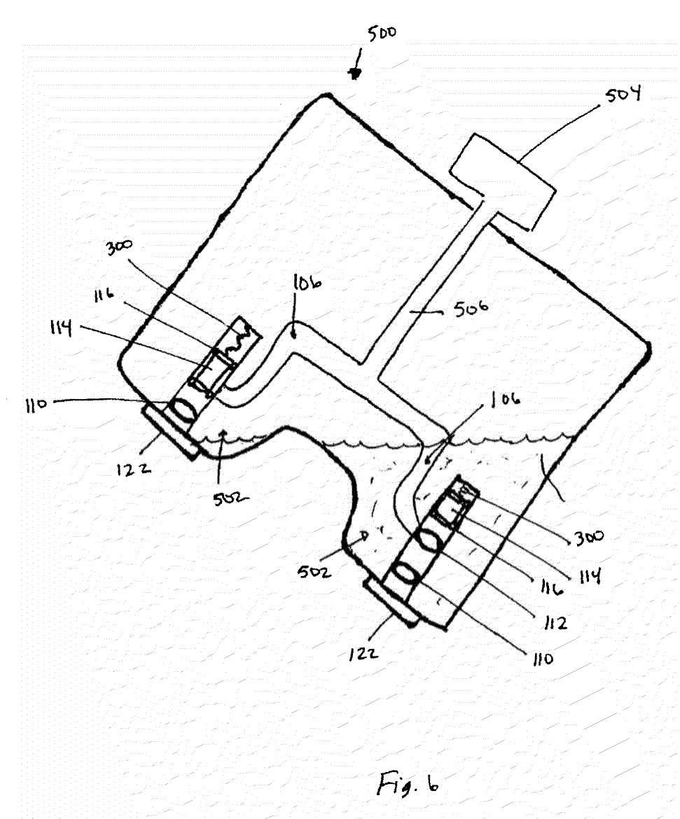

The valve 100 may also contain a mounting flange 122, which may be used to attach the valve(s) to a reservoir 500, as shown in FIGS. 5 and 6. The reservoir 500 may also contain a sump 502, which is the lower portion of the reservoir 500. In one embodiment, the mounting flange 122 is attached to the housing 102, the sleeve or tubular cavity 108 and the reservoir 500. The purpose of the reservoir 500 is to store fluid which flows through the valves 100 and is ultimately supplied to a vehicle. In one embodiment, the fluid stored in the reservoir 500 is oil and the reservoir 500 is an oil pan. However, the reservoir 500 may be any container used to store fluids as known by one skilled in the art.

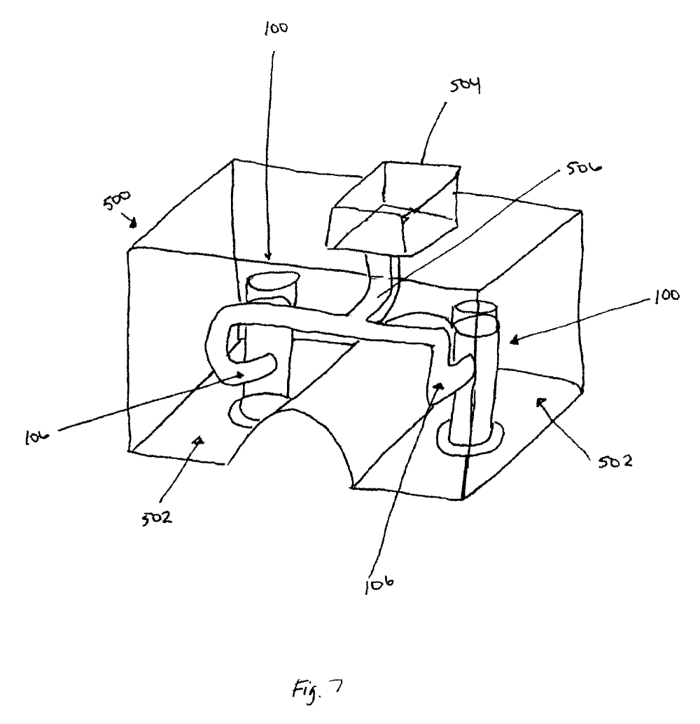

In one embodiment, as shown in FIGS. 5-7, the reservoir 500 contains a plurality of valves within the sump 502. In another embodiment, the reservoir 500 contains a first valve and a second valve. In this embodiment, the first valve is adapted to be in an open position while the second valve is adapted to simultaneously be in a closed position in response to specified variations in fluid levels within the sump 502. FIG. S shows one embodiment of a lubricating system of the present invention when fluid level is equally distributed above the predetermined level in the valves 100, which places all of the valves in the open position. FIG. 6 shows one embodiment of a lubricating system of the present invention where the reservoir is placed in extreme tilt conditions, wherein the level of fluid is above the predetermined level in the first valve and below the predetermined level in the second valve. As shown in FIG. 6, since the level of fluid is above the predetermined level in the first valve, the first valve is in the open position, and since the level of the fluid is below the predetermined level in the second valve, the second valve is in the closed position.

The lubricating system of the present invention may also include a pump 504. The pump 504 is used to transmit fluid from the reservoir 500 to the internal components of a vehicle. The pump 504 is in fluid communication with each of the outlets 106 of the valves 100. Due to the automatic nature of the valve closing when the fluid level about the valve drops, air and gas cannot enter the conduit 506 connecting the pump 504 with the valves 100. In one embodiment, the pump 504 is an oil pump, which lubricates the internal components of an engine.

While preferred embodiments and example configurations have been shown and described, it is to be understood that various further modifications and additional configurations will be apparent to those skilled in the art. It is intended that the specific embodiments and configurations disclosed are illustrative of the preferred and best modes for practicing the invention, and should not be interpreted as limitations on the scope of the invention as defined by the appended claims and it is to be appreciated that various changes, rearrangements and modifications may be made therein, without departing from the scope of the invention as defined by the appended claims.

What is claimed is:

1. A gravity-activated valve for use in supplying an uninterrupted supply of fluid from a fluid reservoir, said gravity-activated valve comprising:
a housing having an outlet, an inlet positioned below the outlet, and a sleeve disposed within the housing;
a buoyant piston disposed within the sleeve and adapted to move between an open position and a closed position, the piston is positioned above the outlet when the piston is in the open position to allow fluid flow through the outlet, the piston is positioned proximate the outlet when the piston is in the closed position to prevent fluid flow through the outlet, the piston is in the open position when the fluid level exceeds a predetermined fluid level and the piston is in the closed position when the fluid level is at or below said predetermined fluid level; and
a plurality of gaskets, the gaskets adapted to create a seal between the piston and the sleeve.

2. The gravity-activated valve of claim 1, the housing outlet in fluid communication with a pump.

3. The gravity-activated valve of claim 2, wherein the pump is an oil pump.

4. The gravity-activated valve of claim 3, wherein the piston has a top section and bottom section, wherein the gaskets are o-rings mounted about each of the top and bottom sections.

5. The gravity-activated valve of claim 4, wherein the top section of the piston operatively cooperates with a spring mounted to an upper portion of the sleeve.

6. The gravity-activated valve of claim 1, wherein the fluid reservoir is an oil pan and the fluid is oil.

7. The gravity-activated valve of claim 5, wherein the sleeve is disposed within the housing, the sleeve having an intake opening and an exit opening, the intake opening in fluid communication with inlet, the exit opening in fluid communication with the outlet.

8. The gravity-activated valve of claim 7, further comprising a mounting flange connected to the housing and the sleeve, the mounting flange adapted to connect to a reservoir.

9. A lubricating system for an internal combustion engine for supplying an uninterrupted supply of fluid comprising:
a reservoir for holding lubricating fluid, the reservoir having a sump;
a plurality of valves located in the sump, each of said valves comprising:
a housing having an outlet, an inlet positioned below the outlet, and a tubular cavity disposed within the housing;
a buoyant piston disposed within the tubular cavity and adapted to move between an open position and a closed position, the piston is positioned above the outlet when the piston is in the open position to allow fluid flow through the outlet, the piston is positioned proximate the outlet when the piston is in the closed position to prevent fluid flow through the outlet, the piston further responsive to the level of the fluid in the reservoir at the inlet such that the piston is in the open position when the fluid level at the inlet is above a predetermined level, and the piston is in the closed position when the fluid level at the inlet is at or below said predetermined level;
a plurality of gaskets, the gaskets adapted to create a seal between the piston and the tubular cavity;
a pump in fluid communication with the outlet of each of said valves.

10. The lubricating system of claim 9, wherein the reservoir is an oil pan and the pump is an oil pump.

11. The lubricating system of claim 10, further comprising a mounting flange connected to the housing and the reservoir, and wherein the gaskets are o-rings.

12. The lubricating system of claim 11, the tubular cavity further comprising an upper portion, said tubular cavity further comprising a spring attached to the upper portion thereof and operatively cooperating with the piston to urge said piston to the closed position.

13. The lubricating system of claim 12, wherein the fluid is oil.

14. The lubricating system of claim 13, wherein the gaskets are o-rings.

15. The lubricating system of claim 9, the tubular cavity having an intake opening and an exit opening, the intake opening in fluid communication with inlet, the exit opening in fluid communication with the outlet.

16. A reservoir for supplying an uninterrupted supply of fluid from a fluid reservoir, said reservoir comprising:
a sump for holding fluid;
a plurality of valves located in the sump, the valves comprising:
a housing having an outlet, an inlet positioned below the outlet, and a sleeve disposed within the housing;
a buoyant piston disposed within the sleeve and adapted to move between an open position and a closed position, the piston is positioned above the outlet when the piston is in the open position to allow fluid flow through the outlet, the piston is positioned proximate the outlet when the piston is in the closed position to prevent fluid flow through the outlet, the piston is in the open position when the fluid level exceeds a predetermined fluid level, the piston is in the closed position when the fluid level is at or below said predetermined level;
a plurality of gaskets, the gaskets adapted to create a seal between the piston and the sleeve; and
a mounting flange connected to the sleeve and the sump.

17. The reservoir of claim 16, wherein the fluid is oil and the gaskets are o-rings.

18. The reservoir of claim 16, wherein a first valve is adapted to be in an open position while a second valve is adapted to simultaneously be in a closed position in response to specified variations in fluid levels within the sump.

19. The reservoir of claim 18, the sleeve further comprising an intake opening and an exit opening, the intake opening in fluid communication with inlet, the exit opening in fluid communication with the outlet.

20. The reservoir of claim 19, the sleeve further comprising an upper portion, said sleeve further comprising a spring attached to the upper portion thereof and operatively cooperating with the piston to urge said piston to the closed position.
